(19) United States
(12) Patent Application Publication
(10) Pub. No.: US 2004/0012114 A1
(43) Pub. Date: Jan. 22, 2004

(54) Method for producing a granulated intermediate product that is to be subjected to a subsequent processing in oder to form plastic shaped bodies

(76) Inventors: Peter Eyerer, Karlsruhe (DE); Emilia Inone, Pfinztal (DE); Helmut Nagele, Beuernfeld (DE); Wilhelm Eckl, Karlsruhe (DE); Norbert Eisenreich, Pfinztal (DE); Jurgen Pfitzer, Stockhausen (DE)

Correspondence Address: Dr. Paul J Vincent, Lichti Lempert & lsch, Bergwaldstr 1, D-76227 Karlsruhe Germany, DE

(21) Appl. No.: 10/363,218

(22) PCT Filed: Aug. 30, 2001
(86) PCT No.: PCT/EP01/10006

(30) Foreign Application Priority Data
Sep. 15, 2000 (DE) 100457940

(51) Int. Cl. B28B 3/00

(52) U.S. Cl. 264/117; 264/319

(57) ABSTRACT

For producing a granulated intermediate product which consists of a fine-particle thermoplastic or thermoelastic polymer and substantially inert fillers for further processing into plastic shaped bodies through thermoplastic processing methods it is proposed to mix the polymer in the form of powder or particles with the fillers and compact the powder mixture without plastification of the polymer exclusively under mechanical pressure into pourable agglomerates with larger grain size. Such an agglomerate can be processed into shaped bodies in the same manner as a conventional plastic granulated material, wherein thermal damage to the fillers and the molecular structure of the polymer is reliably prevented during production of the intermediate product and extremely high fill fractions can be achieved.

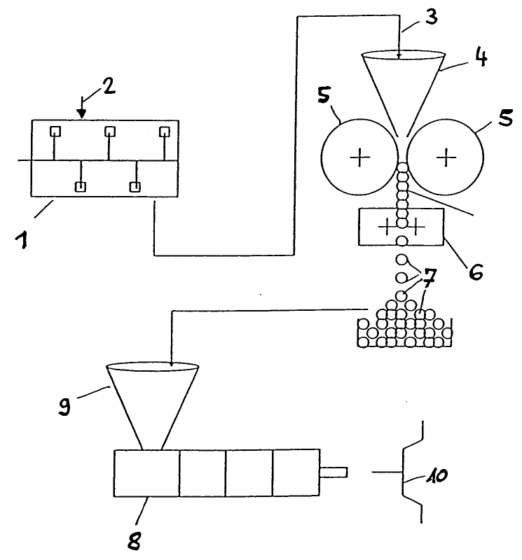

Translation of PCT/EP01/10006 as filed on Aug. 30, 2001

The invention concerns a method for producing a granulated intermediate product from at least one substantially powdery or particle-shaped thermoplastic and/or thermoelastic polymer and substantially inert fillers for further processing into plastic shaped bodies through thermoplastic processing methods by mixing the polymer and the fillers and compacting the powder mixture into a granulated matter of larger grain size.

Thermoplastic and thermoelastic polymers are usually processed, in the form of granulated matter, into shaped bodies through injection molding machines or extruders. Towards this end, the raw material producer must first bring the polymer into a pourable granulated form to ensure reliable subsequent processing. Granulation can be effected with extruders through melting-on the polymer and subsequent shaping and cooling of the produced granulated matter. This process requires energy and careful temperature control to prevent damage to the molecular structure of the polymer. During processing into the shaped body, the granulated matter is again melted-on and heated. The same happens when regenerated plastic materials are used. Towards this end, the plastic particles are usually ground into smaller fragments to produce granulated matter therefrom through remelting.

To influence the material properties of the final product in the desired fashion, fiber materials which are either cut short or in the form of powder are added either during production of the raw granulated matter or during melting-on thereof for producing the shaped body. For conventional extrusion into raw granulated matter or extrusion of the raw granulated matter into a shaped body, fiber fill fractions of up to a maximum of 65 mass % can be obtained. In particular, natural fiber fillers may be thermally damaged since the fibers are subjected to thermal stress through granulation for plastification of the polymer as well as during further processing of the granulated matter into the shaped body.

DE 198 34 132 A1 describes a device for producing a granulated intermediate product from thermoplastic polymers and natural fibers in the form of a die press. The die press comprises an annular space which can be loaded axially with the powder mixture to be granulated which is delimited at its periphery by a perforated die and in which a revolving friction blade is disposed to press the charge through the perforated die. The space formed between the friction blade and the outer wall of the annular space serves as a plastification chamber for the fed polymer. The known device ensures variation of the shearing forces acting on the powder mixture and therefore permanent uniform distribution of the fibers in the plastificate. Moreover, exact temperature control of the plastification chamber is expected since it is relatively small and closed and thermal impairment of the fibers is minimized. However, there is a risk of thermal damage to the polymers and also, in particular, to the admixed fibers due to the at least two-fold plastification of the powder mixture, i.e. during granulation and during further processing into shaped bodies.

DE 34 05 185 C2 discloses a further die press for producing granulated matter from polymers mixed with additives. The die is provided with a perforated plate which can be temperature-controlled through which the initial mixture is forced thereby plastifying at least a part thereof. A heating and cooling device associated with the die heats the perforated plate to an operating temperature of between 100° C. and 200° C. prior to operation of the die press and discharges the frictional heat generated during continuing operation to prevent overheating of the plate upper side contacting the initial mixture to ensure perfect mixture of the fine-particle polymer with powdery additives before the actual agglomeration. Moreover, burned deposition and melting of the plastic material onto the die plate should be avoided. The danger of thermal damage to the initial mixture is therefore reduced but not reliably eliminated.

It is the underlying purpose of the invention to propose a cost-reducing method of the above-mentioned type wherein higher fill fractions can be achieved while reliably preventing thermal damage to the powder mixture.

This object is achieved in accordance with the invention in a method of this type in that the powder mixture is compacted into the granulated matter exclusively through mechanical pressure without plastification of the polymer.

Many polymers are produced in the form of powder or particles both in synthetic production as well as in regeneration of plastic material. The situation is similar with natural polymers, e.g. lignin, which is obtained in fine particles from cellulose production through concentration of cellulose waste water. The inventive method is based on such a powder or particle shape of the polymer. The desired fiber materials are added to this polymer powder in appropriately small particle sizes (ranging from cut short to powdery) and uniformly mixed. The resulting homogeneous power mixture is subsequently compacted without plastification thereof exclusively under mechanical pressure into agglomerates with grain sizes which are much larger than those of the initial products.

Practical tests have surprisingly shown that agglomerates produced in this fashion are inherently stable and are non-abrasive and can be supplied, packed and dosed as pourable intermediate products for processing into plastic shaped bodies in the conventional fashion using any thermoplastic processing method such as extrusion, injection molding or the like. The agglomerates can thereby be added to unfilled polymers as a master batch or can be directly processed into shaped bodies. Practical tests have also shown that this pressing agglomeration produces considerably higher filler fractions, in particular, for fibrous fillers which can assume a mass portion of up to 95% relative to the powder mixture used without significantly impairing bonding in the polymer. In particular, the inventive method permits filling of any synthetic thermoplastic or thermoelastic polymers, such as polyethylene, polypropylene, etc, with high portions of natural fibers which leads to considerable cost reduction through substitution of a larger part of the generally more expensive polymers with fibers. The conventional method achieves fill fractions of a maximum of only 65 mass %.

The powder mixture is preferably compacted with a linear force of between 5 kN/cm and 30 kN/cm. Pressures of this type can be easily realized in molding presses, screw or roller presses to thereby obtain shaped agglomerates without plastification thereof.

In continuous screw or roller pressing, the material obtained can be disintegrated through simple disintegrating processes into the desired particle size depending on the consistency. The powder mixture may instead be compacted through section rolling into shaped agglomerates. Another possibility is to compact the powder mixture into an optionally profiled strand using a screw press and to disintegrate the strand into the agglomerates of desired particle size.

Depending on the device used for mechanical compacting, in particular the shearing stress of the powder mixture may require cooling of the powder mixture during compacting due to the produced frictional heat. This may be effected e.g. by cooling the machine parts which are in contact with the powder mixture. To safely and reliably prevent even surface plastification of the used polymers, the powder mixture should be kept at a maximum of 50° C., preferably a maximum of 40° C. In case of preferred use of rollers or section rollers, cooling can be generally omitted, in particular, when the arrangement is open. The use of rollers made from a material having a relatively high heat conducting coefficient, e.g. metals or metal alloys, is advantageous since the frictional heat is permanently discharged. This heat is much less than that generated in die presses due to the smaller shearing forces.

The fiber material- added to the polymer powder preferably has a particle size of between 10 μm and 10,000 μm.

The powder mixture is preferably compacted into agglomerates having a particle size of between 1 mm and 10 mm.

The powder mixture is preferably substantially dry processed into the agglomerates. If the fiber material is a natural material, it may have a certain residual moisture and be added in an amount of up to 95 mass %.

As mentioned above, the polymers may be synthetic and/or natural polymers or also mixtures thereof. The inventive method can be used with particular advantage with a powder mixture of lignin powder produced in cellulose production and fillers of natural fibers.

The invention is described below with reference to a system for carrying out the method which is schematically shown in the drawing.

A powdery polymer or a powdery polymer mixture and fillers of powdery to fibrous consistency are fed into and uniformly mixed in a mixer 1 indicated with directional arrow 2. The mixer 1 can be a continuous or a batch mixer. The mixture leaving the mixer is fed at 3 into a funnel 4 or the Ike from which the powder mixture is metered and discharged or removed. In the embodiment shown it reaches the roller gap between two press rollers 5 and is compacted there purely mechanically into a strand or band-shaped material (scab) which is subsequently disintegrated into pourable agglomerates 7 in a disintegrating apparatus 6 comprising e.g. revolving beaters or knifes. During compacting of the powder mixture in the roller gap, it is heated only minimally through friction to approximately 25° to 40° in dependence on the initial temperature of the powder mixture such that any thermal damage to the material and in particular plastification of the polymers used is reliably prevented.

The pourable agglomerates 7 can be processed into a plastic shaped part 10 using any conventional thermoplastic processing methods, e.g. feeding into an extruder 8 with feeding funnel 9 or a conventional injection molding machine and melting of the polymer.

Embodiments:

1. 10 mass % polyethylene powder and 90 mass % wood dust or short-cut wood fibers are uniformly mixed. The powder mixture is agglomerated into a profiled strand in a strand or roller press with a linear force of between 5 kN/cm and 30 kN/cm. The strand is subsequently disintegrated into individual agglomerates with a particle size of between 1 mm and 15 mm.

2. 70 mass % lignin powder from cellulose production is uniformly mixed with 30 mass % short-cut hemp fibers. The powder mixture is compacted between two rollers with a linear force of between 5 kN/cm and 30 kN/cm and the produced material is disintegrated into pourable agglomerates.

1. Method for producing a granulated intermediate product from at least one substantially powdery or particle-shaped thermoplastic and/or thermoelastic polymer and substantially inert fillers for further processing into plastic shaped bodies through thermoplastic processing methods by mixing the polymer and the fillers and compacting the powder mixture into a granulate with larger grain size, characterized in that the powder mixture is compacted into the granulate exclusively under mechanical pressure without plastifying the polymer and is kept at a maximum of 40° C. during compacting

2. Method according to claim 1, characterized in that the powder mixture is compacted with a linear force of more than 5 kN/cm.

3. Method according to claim 1 or 2, characterized in that the powder mixture is compacted with a linear force of less than 30 kN/cm.

4. Method according to any one of the claims 1 through 3, characterized in that the powder mixture is compacted into shaped agglomerates in a press.

5. Method according to any one of the claims 1 through 3, characterized in that the powder mixture is compacted using rollers.

6. Method according to claim 5, characterized in that the powder mixture is compacted into shaped agglomerates through section rolling.

7. Method according to claim 5 or 6, characterized in that the powder mixture is compacted through rollers into a planar material which is then disintegrated into the agglomerates.

8. Method according to any one of the claims 1 through 3, characterized in that the powder mixture is compacted through a screw press into an optionally profiled strand and the strand is disintegrated into the agglomerates.

9. Method according to any one of the claims 1 through 8, characterized in that the powdery or particle-shaped polymer is mixed with disintegrated fiber material as filler.

10. Method according to claim 9, characterized in that the fiber material is a natural material.

11. Method according to claim 10 or 11, characterized in that fiber material of a particle size of between 10 μm and 10,000 μm is used.

12. Method according to any one of the claims 1 through 11, characterized in that the powder mixture is compacted into agglomerates having a particle size of between 1 mm and 10 mm.

13. Method according to any one of the claims 1 through 12, characterized in that the powdery or particle-shaped polymer is processed with up to 95 mass % of fillers relative to the powder mixture.

14. Method according to any one of the claims 1 through 13, characterized in that the powder mixture is substantially dry processed into the agglomerates.

15. Method according to any one of the claims 1 through 14, characterized in that synthetic and/or natural polymers or mixtures thereof are used.

16. Method according to any one of the claims 1 through 15, characterized in that lignin powder from cellulose production is used.
